(19) United States
(12) Patent Application Publication
(10) Pub. No.: US 2013/0088596 A1
(43) Pub. Date: Apr. 11, 2013

(54) MONITORING SYSTEM, METHOD FOR CONTROLLING THE SAME, AND SEMICONDUCTOR INTEGRATED CIRCUIT FOR THE SAME

(71) Applicants: Kazuhisa RAITA, Osaka (JP); Akihiro SHIBATA, Osaka (JP); Naoyuki SHIMODA, Osaka (JP); Takeshi ENDOU, Osaka (JP)

(72) Inventors: Kazuhisa RAITA, Osaka (JP); Akihiro SHIBATA, Osaka (JP); Naoyuki SHIMODA, Osaka (JP); Takeshi ENDOU, Osaka (JP)

(73) Assignee: PANASONIC CORPORATION, Osaka (JP)

(21) Appl. No.: 13/604,493

(22) Filed: Sep. 5, 2012

Related U.S. Application Data
(63) Continuation of application No. PCT/JP2011/001274, filed on Mar. 3, 2011.

(30) Foreign Application Priority Data
Mar. 5, 2010 (JP) 2010-049740

(51) Int. Cl. H04N 7/18

(52) U.S. Cl. CPC H04N 7/18
USPC 348/148; 348/143

(57) ABSTRACT

An image comparison section provided in a monitoring system compares current image data with past image data acquired in at least one preceding cycle when a vehicle is determined to be in motion on the basis of an output signal input from a motion sensing section. On the basis of a comparison result, the image comparison section determines whether or not a camera or an image processing section broke down. When there is a failure, the image comparison section outputs an output signal reporting the failure to the image processing section. Upon receipt of the output signal, the image processing section performs image processing intended for the event of a failure, and transmits failure information while superimposing the failure information on an image signal, thereby changing a display device to a monochrome display or an alarm display.

### BACKGROUND OF THE INVENTION

1. Field of the Invention

The present invention relates to a monitoring system for monitoring a mobile object, a method for controlling the system, and a semiconductor integrated circuit for the system.

2. Description of the Related Art

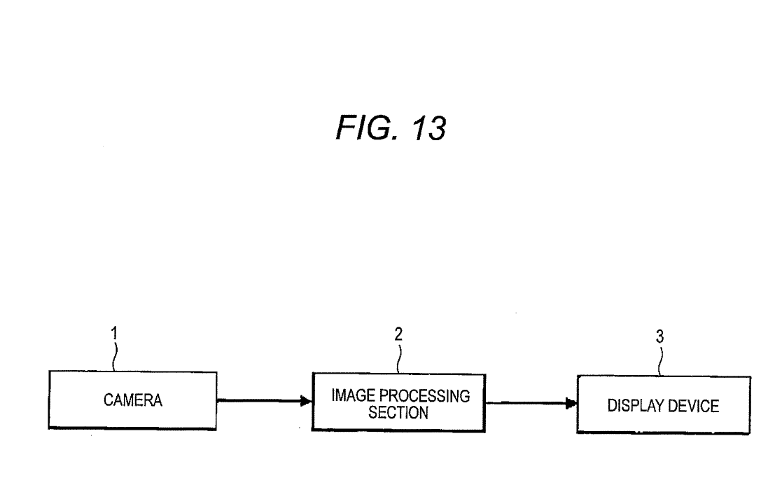

A monitoring system that displays on a display device image data pertaining to surroundings of a vehicle captured by a camera or image data generated by synthesis of the images has recently come into widespread as a monitoring system for monitoring a mobile object. FIG. 13 is a section diagram showing a configuration of a related-art monitoring system. The monitoring system shown in FIG. 13 is equipped with a camera 1, an image processing section 2, and a display device 3. The image processing section 2 processes image data captured by the camera 1. The display device 3 displays an image input from the image processing section 2. A driver of the vehicle equipped with the monitoring system drives ahead or in reverse on the basis of the information displayed on the display device 3 while confirming safe conditions.

Such a monitoring system is applied to a configuration described in connection with Patent Document 1. Specifically, there is a monitoring system that displays a composite image, such as that broadens a field of view and enables a driver to drive in reverse while confirming only a display device. Moreover, in order to make positional relationships among proximal surroundings of a driver's vehicle easy to perceive, another monitoring system offers information about the proximity of the driver's vehicle to the driver, as well as simultaneously displaying an image of the surroundings as if they were seen from above the driver's vehicle.

Patent Document 1: JP-A-2002-125224

### SUMMARY OF THE INVENTION

However, the related-art monitoring system may cause a problem when information captured by a camera, or the like, is not properly transmitted to the display device. It is necessary to enhance a fail-safe function by eliminating the risk of occurrence of such a problem and upgrading safety.

Specifically, in the event of a failure of the monitoring system, the system must appropriately cope with a situation where an image appearing correct in the eyes of the driver is displayed on the display device. For instance, there is a necessity for a fail-safe function intended for a situation where the monitoring system has gone down for any failures while an image preceding an image originally to be output still remains on the display device.

When an image apparently showing a failure is displayed on the display device, the driver realizes the failure of the monitoring system. The driver can, at this time, avoid an accident by temporarily moving a vehicle to a safe location through use of an ancillary function, like a rearview mirror. However, if the driver continues to drive while an image preceding an image originally to be displayed still remains on the display device, the probability of occurrence of an accidental contact will increase.

The objective of the present invention is to provide a monitoring system capable of informing a user of occurrence of a failure of the monitoring system if the monitoring system has gone down for any reasons while an image preceding an image originally to be displayed still remains on a display device, a method for controlling the monitoring system, and a semiconductor integrated circuit for the monitoring system.

The present invention is directed toward a monitoring system that monitors a mobile object comprising: a camera that captures an image of surroundings and outputs an image signal; an image processing section that processes the image signal input from the camera so as to generate image data; a display device that displays an image according to the image data generated by the image processing section; a motion sensing section for sensing that the mobile object is in motion; and an image comparison section that receives an input of image data generated by the image processing section at a predetermined cycle and that compares first image data generated by the image processing section with second image data generated in at least one cycle preceding the first image data when the motion sensing section detects that the mobile object is in motion, wherein the image comparison section has a determination section that determines, from a comparison result, whether there is a failure in the camera or the image processing section; and a transmission section for transmitting failure information to the display device when the determination section determines that there is a failure.

Thereby, when the monitoring system went down because of any failure while an image preceding an image originally to be displayed still remains on the display device, the monitoring system can report the failure of the monitoring system to the driver. Consequently, when the monitoring system is applied to a vehicle serving as a mobile object, the driver can take notice of the failure of the monitoring system and temporarily drives the vehicle to a safe location through use of an ancillary function, like a rearview mirror, thereby enabling avoidance of an accident. Safety of the vehicle can be consequently upgraded, and construction of a safety-sensitive system comes to realization.

The present invention also provides a monitoring system comprising first memory and second memory for storing image data generated by the image processing section, wherein the first memory stores the first image data; and the second memory stores the second image data.

As a result, continual image comparison can thereby be carried out by comparing two pieces of image data with each other. In the event of occurrence of a failure, user's attention can be immediately called.

Moreover, the present invention provides a monitoring system in which each of the first memory and the second memory has at least two pieces of image data or more.

Continual image comparison can thereby be carried out by comparing two pieces of image data. When a failure occurred, user's attention can be immediately called, and image data can be stored over a plurality of cycles. Using the thus-stored image data for comparison makes it easy to determine whether or not the trouble is a failure or a temporal failure.

The present invention also provides a monitoring system in which the image comparison section halts image comparison when a failure is detected.

An alarm screen generated by the image processing section and preceding image data are thereby compared with each other. Thus, it is possible to prevent a case where the system has no failure because of a discrepancy between images.

The present invention provides a monitoring system in which the second memory is provided within the image comparison section.

It thereby becomes possible to shorten a signal transmission distance and prevent occurrence of a delay in signal transmission. Further, there is yielded an advantage of a reduction in area of a substrate on which a semiconductor integrated circuit is populated and power consumption.

The present invention provides a monitoring system in which the failure information transmitted from the image comparison section is transmitted to the display device by way of the image processing section.

Transmitting failure information by way of the image processing section makes it possible to superimpose alarm information on a display screen or change a display mode, like a color or brightness of an alarm display screen, thereby facilitating the attracting of driver's attention.

The present invention also provides a monitoring system comprising a device for reporting a failure in addition to having the display device, wherein the failure information transmitted from the image comparison section is transmitted to the device that reports the failure without involvement of the image processing section.

Failure information can thereby be output to the display device without involvement of the image processing section. Even when all functions of the image processing section are un-trustable, occurrence/nonoccurrence of a failure can be reported. Specifically, when a failure is transmitted and when a failure exists in a portion of the image processing section that performs image processing and outputs a result to the display device, the driver's attention can be called without fail.

The present invention also provides a monitoring system in which the display device provides a monochrome display or an alarm display in accordance with the failure information transmitted by the transmission section.

The user can thereby be able to realize a failure easily.

The present invention also provides a monitoring system in which, when the mobile object is a vehicle, the motion sensing section senses that the vehicle is in motion by use of a tire rotation signal and a speed signal or an operation signal of a speed meter.

When the vehicle is in motion, a failure in the monitoring system can thereby be transmitted to the driver, so that an accident can be avoided.

The present invention also provides a monitoring system in which the image processing section has a captured image processing section, an alarm display image generation section, and a display image selection section; and, when the image comparison section determines that there is a failure, the display image selection section causes the display device to display image data generated by the alarm display image generation section in preference to the image data generated by the captured image processing section.

Thereby, transmitting failure information by use of image data generated by the alarm display screen generation section facilitates attracting of the user's attention in a straightforward manner.

The present invention provides a monitoring system in which at least the image processing section, the motion sensing section, and the image comparison section are implemented on one semiconductor integrated circuit substrate.

It thereby becomes possible to shorten a signal transmission distance and prevent occurrence of a delay in signal transmission. Further, there is yielded an advantage of a reduction in area of a substrate on which a semiconductor integrated circuit is populated and power consumption.

The present invention provides a monitoring system in which at least one of the first memory and the second memory is external memory disposed outside the semiconductor integrated circuit substrate.

It thereby becomes possible to attempt to reduce the size of a semiconductor integrated circuit.

The present invention also provides a monitoring system comprising: a signal generation section for generating a signal corresponding to the predetermined cycle with respect to the image comparison section, wherein the signal generation section is configured by means of hardware capable of changing the cycle or a combination of hardware with software.

It thereby becomes possible to detect a failure of the monitoring system at a cycle conforming to motion of the mobile object.

The present invention also provides a method for controlling a monitoring system that monitors a mobile object comprising: an image processing step of processing an image signal input from a camera that captures an image of surroundings and outputs an image signal, thereby generating image data; a display step of displaying an image according to the image data generated in the image processing step; a motion sensing step of sensing that the mobile object is in motion; an image comparison step of receiving an input of image data generated by the image processing step at a predetermined cycle and comparing current image data generated in the image processing step with past image data generated in at least one cycle preceding generation of the image data when it is detected in the motion sensing step that the mobile object is in motion; a determination step of determining, from a comparison result, whether there is a failure in the camera or an image processing section; and a transmission step of transmitting failure information to a display device when it is determined in the determination step that there is the failure.

Thereby, when the monitoring system went down because of any failure while an image preceding an image originally to be displayed still remains on the display device, the monitoring system can report the failure of the monitoring system to the driver. Consequently, when the monitoring system is applied to a vehicle serving as a mobile object, the driver can take notice of the failure of the monitoring system and temporarily drives the vehicle to a safe location through use of an ancillary function, like a rearview mirror, thereby enabling avoidance of an accident. Safety of the vehicle can be consequently upgraded, and construction of a safety-sensitive system comes to realization.

The present invention also provides a semiconductor integrated circuit comprising: an image processing section that processes an image signal input from a camera so as to generate image data; a motion sensing section for sensing that the mobile object is in motion; and an image comparison section that receives an input of image data generated by the image processing section at a predetermined cycle and that compares first image data generated by the image processing section with second image data generated in at least one cycle preceding the first image data when the motion sensing section detects that the mobile object is in motion, wherein the image comparison section has a determination section that determines, from a comparison result, whether there is a failure the camera or the image processing section; and wherein failure information is output when the determination section determines that there is the failure.

Thereby, when the monitoring system went down because of any failure while an image preceding an image originally to be displayed still remains on the display device, the monitoring system can report the failure of the monitoring system to the driver. Consequently, when the monitoring system is applied to a vehicle serving as a mobile object, the driver can take notice of the failure of the monitoring system and temporarily drives the vehicle to a safe location through use of an ancillary function, like a rearview mirror, thereby enabling avoidance of an accident. Safety of the vehicle can be consequently upgraded, and construction of a safety-sensitive system comes to realization.

The monitoring system, the method for controlling the same, and the semiconductor integrated circuit for the same of the present invention make it possible to inform the user of occurrence of a failure of the monitoring system if the monitoring system has gone down for any reasons while an image preceding an image originally to be displayed still remains on a display device. Therefore, when the present invention is applied to a vehicle, or a mobile object, the driver can recognize occurrence of the failure of the monitoring system and can avoid an accident by temporarily driving the vehicle to a safe location through use of an ancillary function, like a rearview mirror. Safety of the vehicle can thereby be upgraded, and construction of a safety-sensitive system comes to realization.

### BRIEF DESCRIPTION OF THE PREFERRED EMBODIMENTS

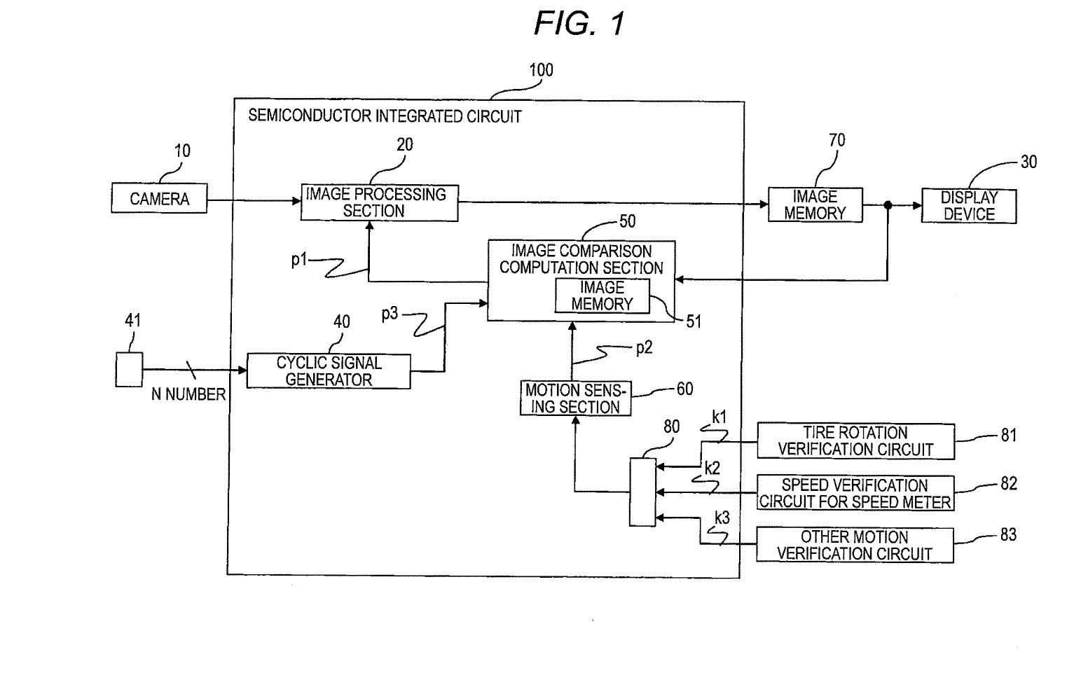

FIG. 1 is a section diagram showing a configuration of a monitoring system of a first embodiment.

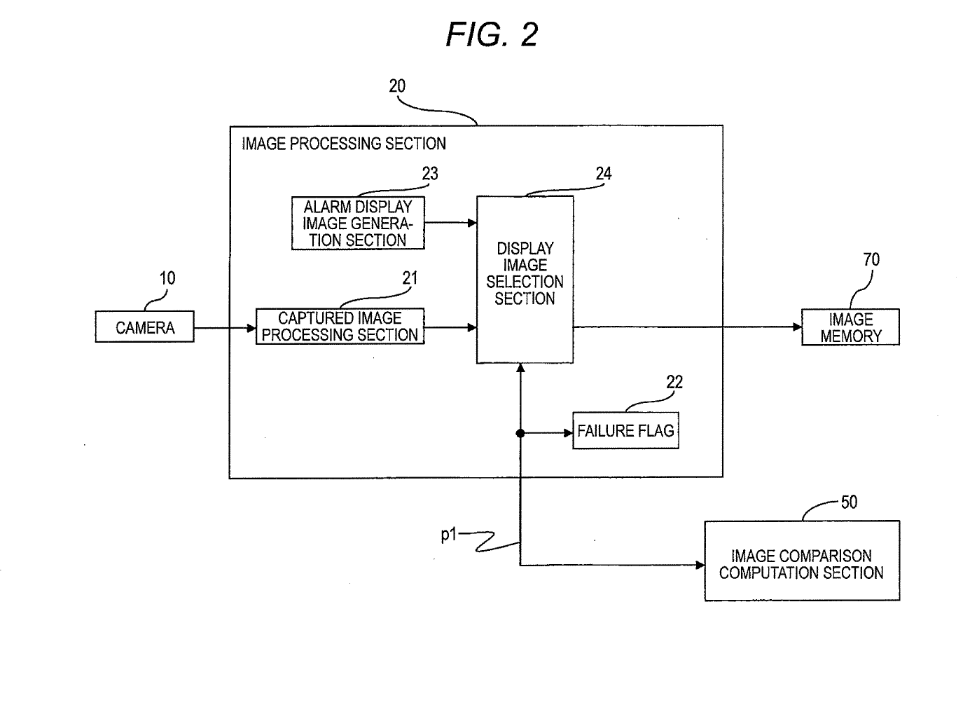

FIG. 2 is a section diagram showing a configuration of an image processing section.

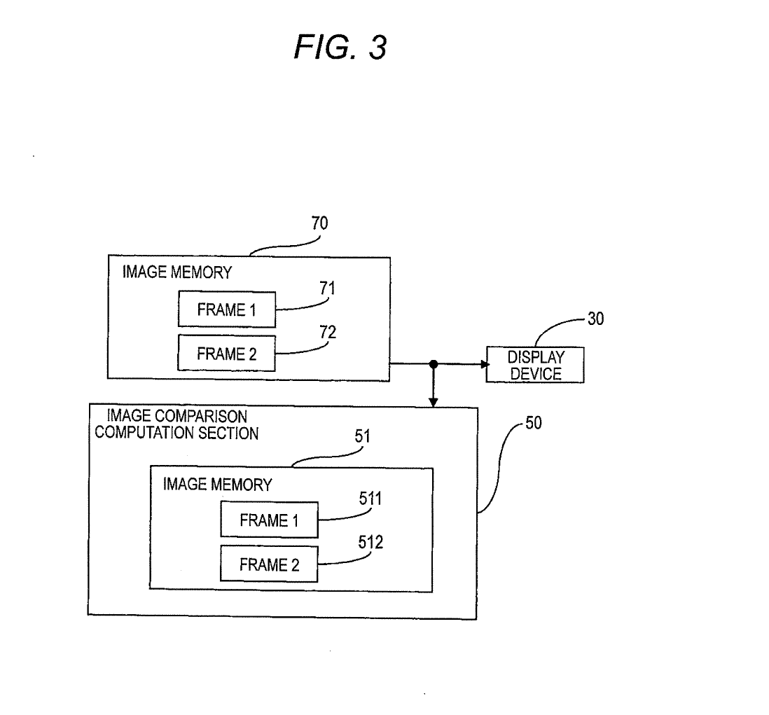

FIG. 3 is a section diagram showing a configuration of image memory.

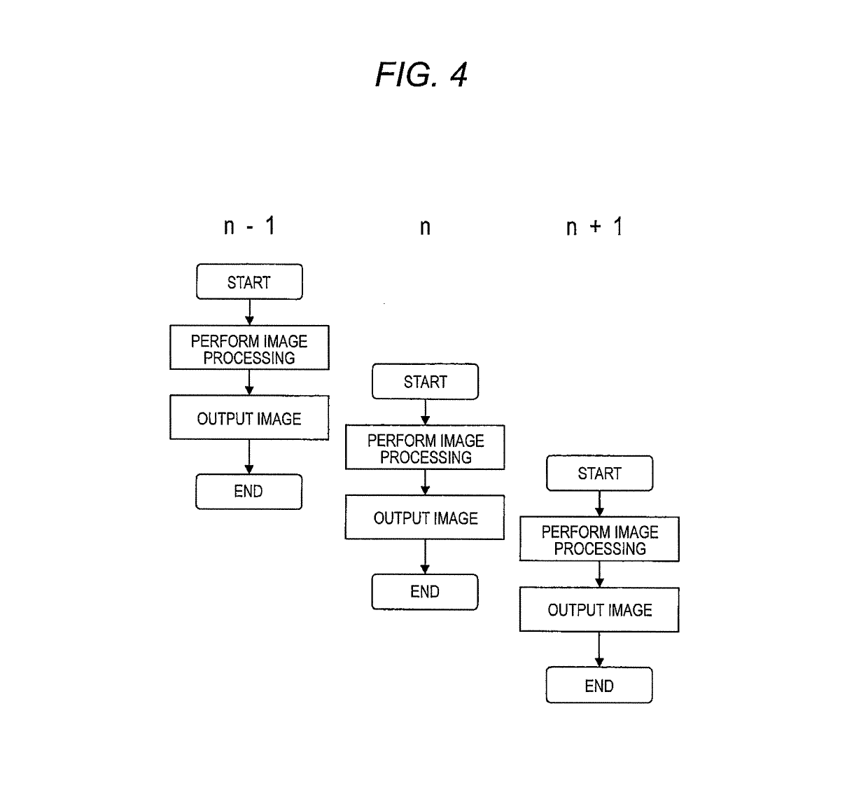

FIG. 4 is a timing chart showing a cycle of image processing in the image processing section.

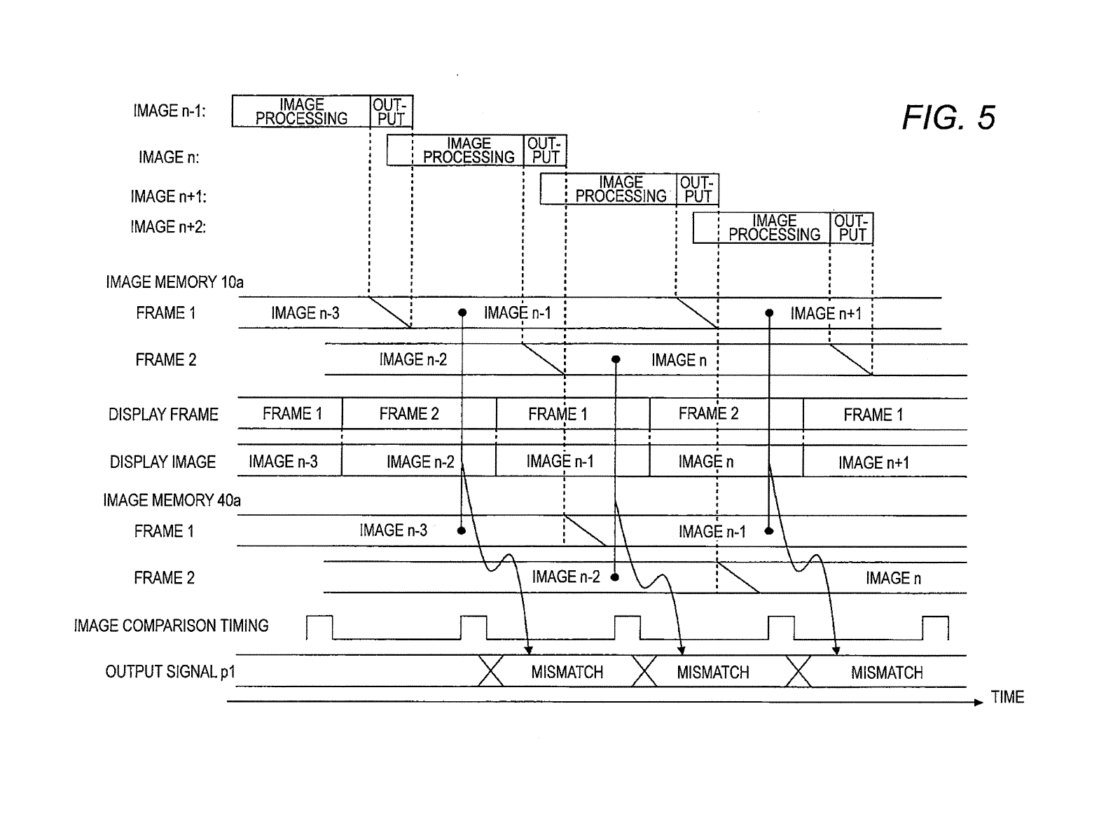

FIG. 5 is a timing chart showing operation procedures of the monitoring system.

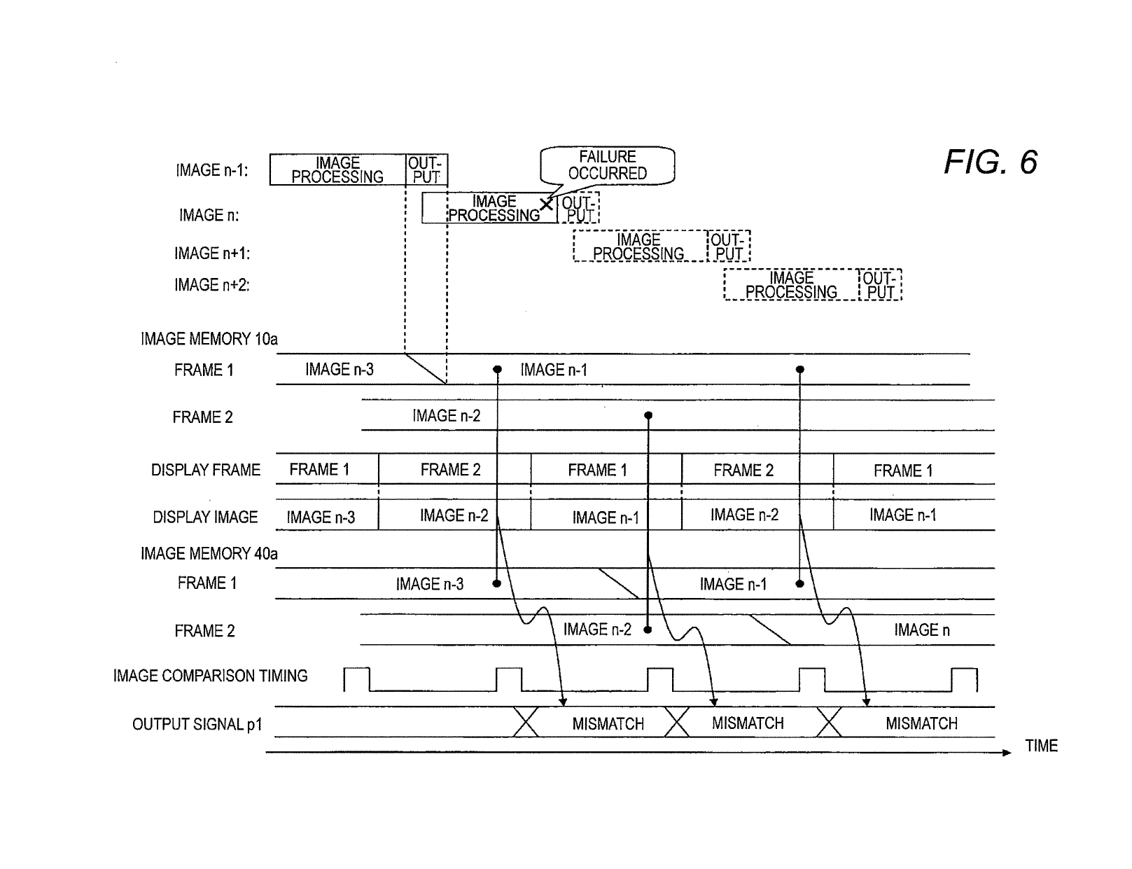

FIG. 6 is a timing chart showing operation procedures of the monitoring system.

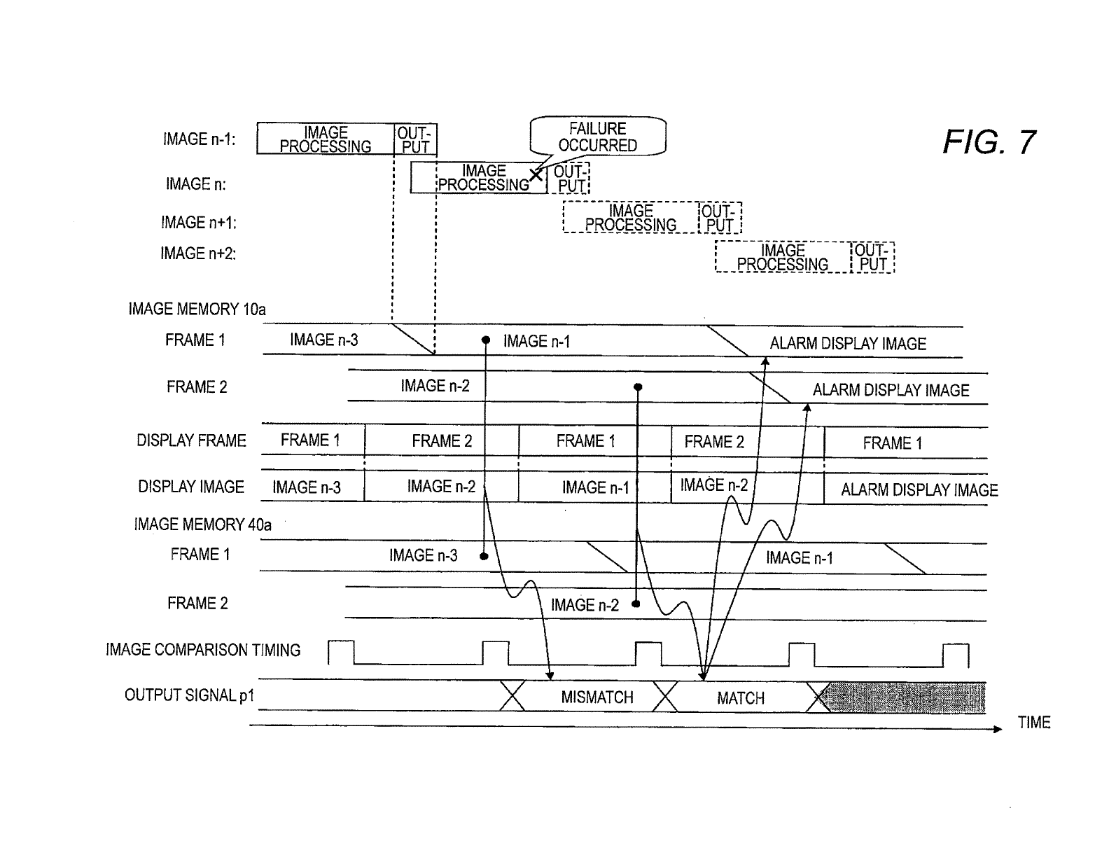

FIG. 7 is a timing chart showing operation procedures of the monitoring system.

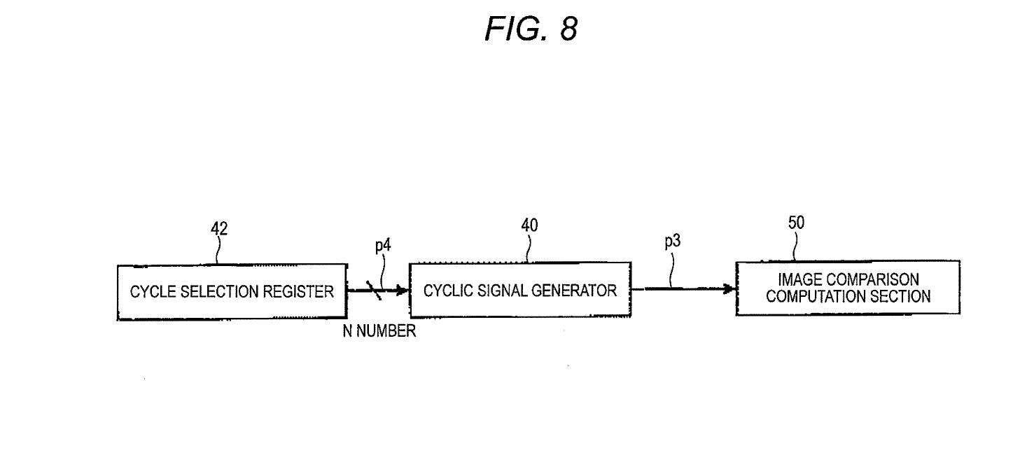

FIG. 8 is a section diagram showing a configuration when a change is made to a cycle at which image comparison is performed.

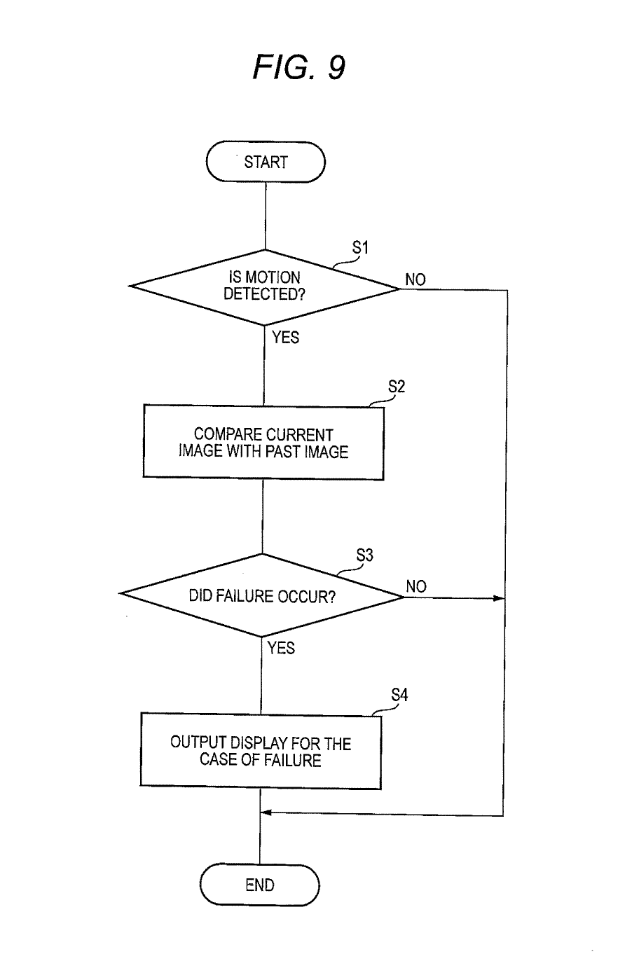

FIG. 9 is a flowchart showing operation procedures of the monitoring system.

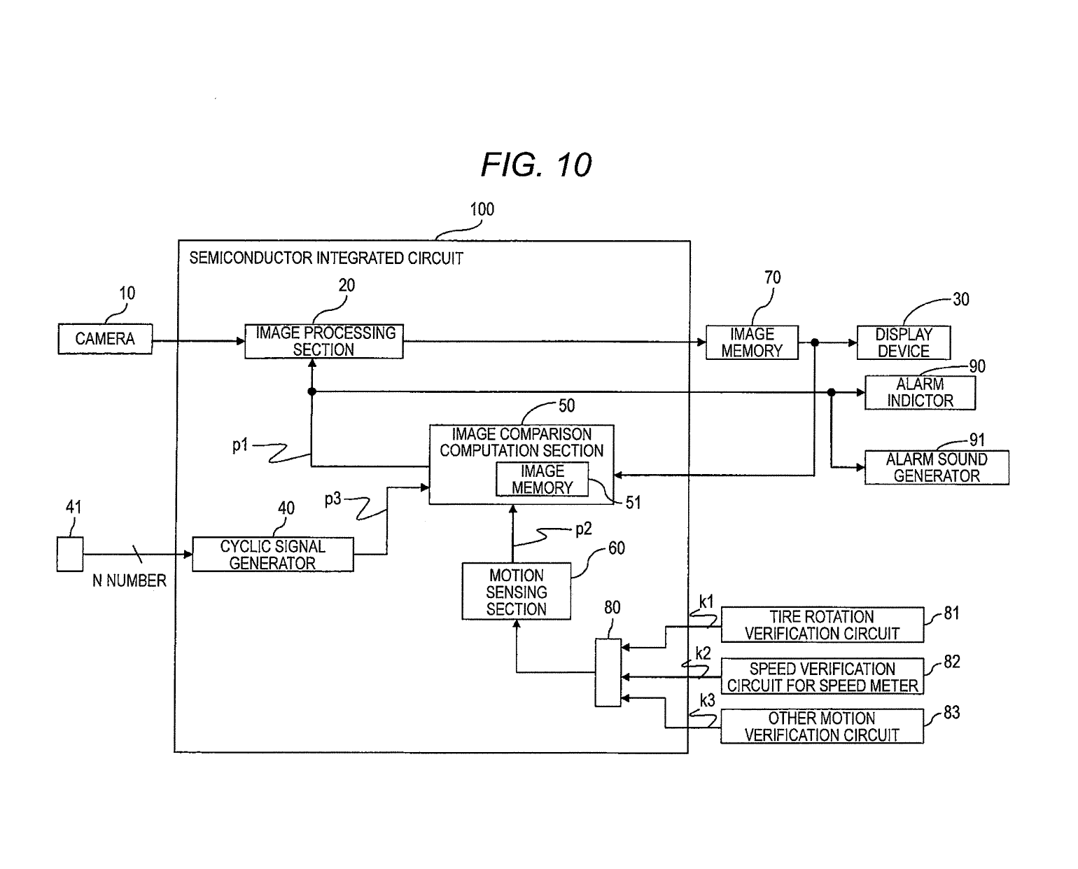

FIG. 10 is a section diagram showing a configuration of a monitoring system of a second embodiment.

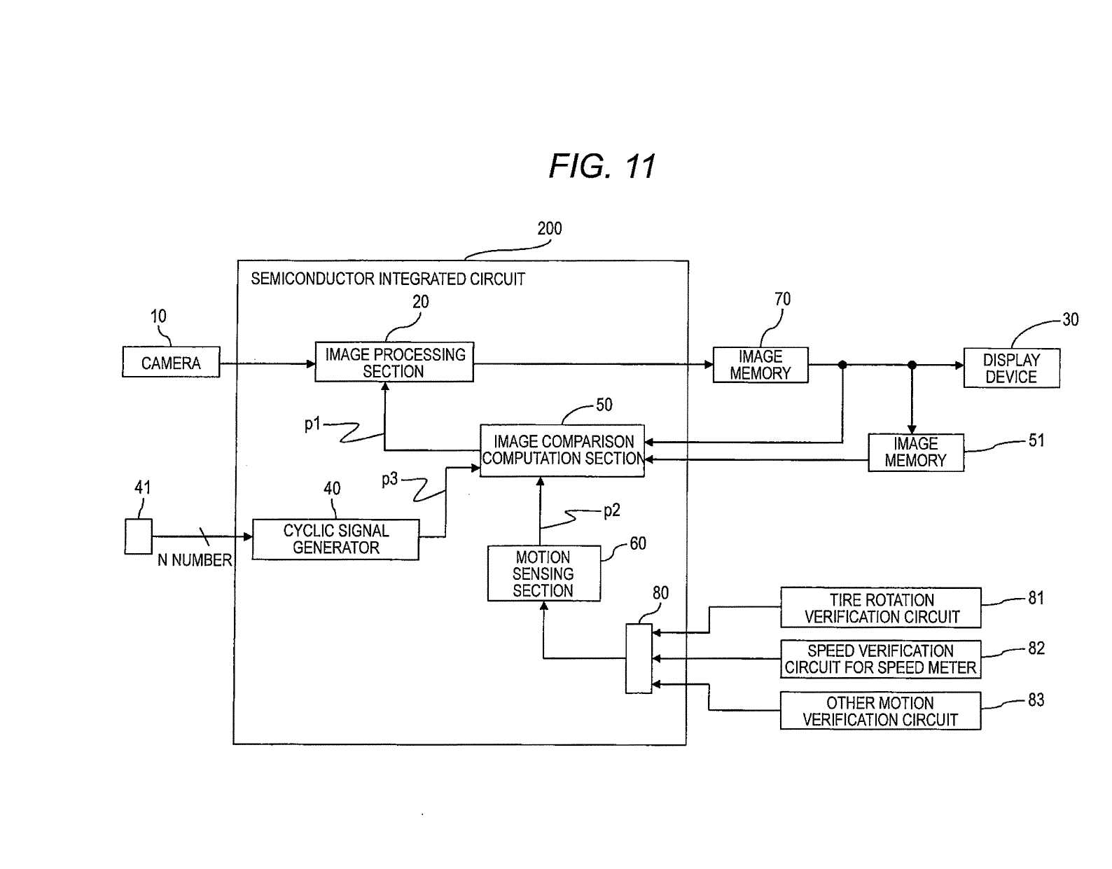

FIG. 11 is a section diagram showing a configuration of a monitoring system of a third embodiment.

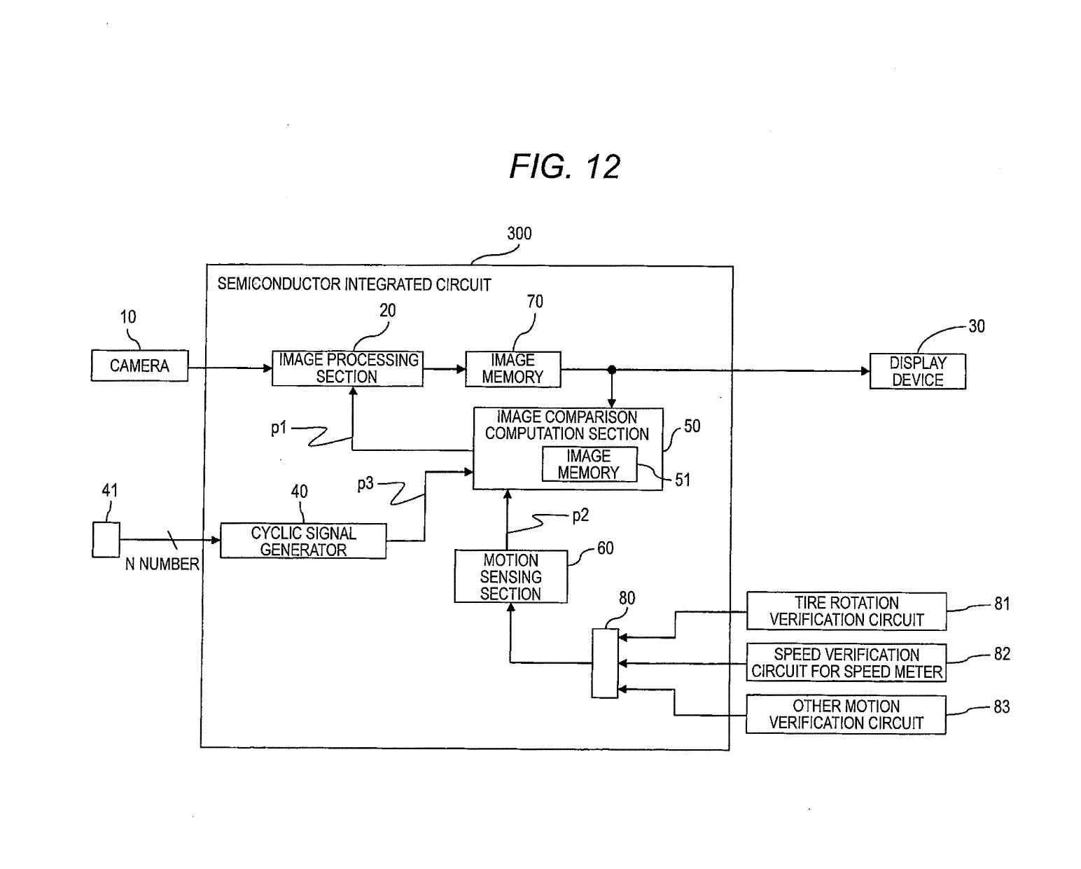

FIG. 12 is a section diagram showing a configuration of a monitoring system of a fourth embodiment.

FIG. 13 is a section diagram showing a configuration of a related-art monitoring system.

### DESCRIPTION OF THE PREFERRED EMBODIMENTS

Embodiments of a monitoring system, a method for controlling the system, and a semiconductor integrated circuit for the same of the present invention are described by reference to the drawings. The monitoring system of the present embodiment is applied to a monitoring system that monitors proximal surroundings of a user's vehicle with a camera mounted on the vehicle.

### First Embodiment

FIG. 1 is a section diagram showing a configuration of a monitoring system of a first embodiment. As shown in FIG. 1, the monitoring system of the first embodiment includes a camera 10; a semiconductor integrated circuit 100 having an image processing section 20, a cyclic signal generator 40, an image comparison computation section 50, and a motion sensing section 60; image memory 70; and a display device 30. The monitoring system has a CPU and memory. The CPU executes a control program stored in the memory, thereby implementing functions of the respective sections along with hardware. Incidentally, it is also possible to implement all of the functions with hardware.

The monitoring system is equipped with at least one camera 10, and the camera 10 captures an image of a vehicle and its surroundings. The image processing section 20 synthesizes a plurality of image signals input from the camera 10, thereby generating a composite image, and outputs the composite image. The image is stored in the image memory 70. Next, the image signal (image data) output from the image memory 70 is output to the display device 30, and the display device 30 displays an image commensurate with the signal. The image signal is also output to the image comparison computation section 50 and stored in image memory 51 provided in the image comparison computation section 50. The motion sensing section 60 detects whether or not the vehicle is in operation and outputs a sensing result to the image comparison computation section 50.

A configuration and operation of the image processing section 20 are now described by reference to FIG. 2. The image processing section 20 includes a captured image processing section 21 that processes an image signal output from the camera 10; a failure flag 22 that is provided with a signal p1 output from the image comparison computation section 50 when there is a failure; an alarm display image generation section 23 that outputs an alarm display image for reporting a failure; and a display image selection section 24 that selects, as an image signal to be displayed on the display device 30, either the signal output from the captured image processing section 21 or the signal output from the alarm display image generation section 23. The image comparison computation section 50 outputs the output signal p1 to the display image selection section 24 to report presence or absence of a failure.

The failure flag 22 is set when the output signal p1 changes to a state where the signal shows that a match exists between images. The failure flag 22 maintains the state until the failure is reset. When the failure is reset, the failure flag 22 is also reset.

When detecting the state of the output signal p1 showing that a match exists between images or when the failure flag is set, the display image selection section 24 selects a signal output from the alarm display screen generation section 23 and inputs the thus-selected signal to the image memory 70. For the rest; namely, an ordinary state where there is not any failure, the display image selection section 24 outputs an image output from the captured image processing section 21 to the image memory 70.

As shown in FIG. 3, each of the image memory 70 and the image comparison computation section 50 has a frame 1 and a frame 2 for storing at least two pieces of image data to be updated at a predetermined cycle.

Processing timing of the image processing section 20 is now described by reference to FIG. 4. The image signal output from the camera 10 is input to the image processing section 20, where the signal is sequentially processed. On this occasion, as shown in FIG. 4, an “n^{th}” image that is a next image can be processed in parallel at the same time when an image produced after processing of an n−1^{th} image is output.

When the motion sensing section 60 detects motion of the vehicle, the image comparison computation section 50 compares at a predetermined cycle the current image data with past image data acquired in at least one preceding cycle by use of the configuration, thereby confirming whether or not the camera 10 or the image processing section 20 has broken down.

The failure detection means is now described in detail by use of the timing charts shown in FIGS. 5 through 7. First, as shown in FIG. 5, the image processing section 20 sequentially processes an image signal input from the camera 10 and outputs the thus-processed image signal. The thus-output images n−1, n, n+1, . . . are alternately stored in the frame 1 or the frame 2 of the image memory 70 and then sequentially output to the display device 30. Concurrently, the image memory 70 outputs an image to the image comparison computation section 50 as well. The image comparison computation section 50 stores the input image one after the other into the frame 1 or the frame 2 of the image memory 51. An image stored in the frame 1 of the image memory 70 is stored in the frame 1 of the image memory 51, and an image stored in the frame 2 of the image memory 70 is stored in the frame 2 of the image memory 51. At timing when an image n−1^{th} is already stored in the frame 1 of the image memory 70, image data will be input to the image memory 51 after a delay. Consequently, an image n−3^{th} is stored in the frame 1 of the image memory 51. When the motion sensing section 60 detects that the vehicle is in motion, the image comparison computation section 50 compares at a given cycle an image stored in the frame 1 of the image memory 70 with an image stored in the frame 1 of the image memory 51 and compares an image stored in the frame 2 of the image memory 70 with an image stored in the frame 2 of the image memory 51. When a discrepancy exists between the images, the image comparison computation section 50 determines that there is not any failure.

In the meantime, when a failure occurs in the image processing section as shown in FIG. 6, the image stored in the image memory is not updated. When the image comparison computation section 50 compares the images stored in the respective frames with each other, a match comes to exist between them. When a match exists between the images, the image comparison computation section 50 has determined that there is a failure. As shown in FIG. 7, an alarm display image to report a failure to the driver is stored in both the frame 1 and the frame 2 of the image memory 70 that inputs images to the display device 30.

As mentioned above, the image comparison computation section 50 performs image matching during failure detection, thereby determining similarities between the two pieces of image data to be compared (i.e., current image data and past image data). Specifically, when a high correlation exists between the two images, the two images are determined to be substantially identical. Since the two images remain unchanged despite occurrence of a change in circumstances of the surroundings of the vehicle, a failure is determined to exist. In the meantime, when a low correlation exists between the two images, the two images are determined to be different from each other. Hence, it is determined that there is not any failure. In the event of a failure, the image comparison computation section 50 outputs to the image processing section 20 an output signal p1 reporting the failure.

Upon receipt of the output signal p1 reporting the failure, the image processing section 20 performs image processing intended for the case of failure of the camera 10 or the image processing section 20. Specifically, the image processing section 20 outputs an image signal of the alarm display image, thereby changing the display on the display device 30 to a monochrome display or an alarm display. However, the above operation is based on the premise that the image processing section 20 maintains a normal failure-free function of performing image processing for failure and transmitting failure information to the display device 30.

Upon receipt of the output signal p1 reporting that a match has once existed between images, the image processing section 20 stops outputting an image until a failure state is reset. At this time, the display device 30 keeps displaying the alarm display image stored in the image memory 70. Further, after outputting the output signal p1 reporting that the match has once existed between images, the image comparison computation section 50 can halt image comparison until the failure state is reset.

When the image comparison computation section 50 performs comparison, the predetermined cycle is set to a period that is considerably shorter than a period of reaction time that is a sum of a reaction time of a person who attempts to put a brake on the vehicle and a mechanical time elapsing before the vehicle comes to a stop. As mentioned previously, it becomes possible to determine whether or not the trouble is a failure or a temporal failure, by means of checking motion of the vehicle in a certain period of time over a plurality of cycles.

The motion sensing section 60 is equipped with a selector circuit 80 that selects any one from a plurality of circuits for detecting vehicle motion by means of different sensing systems. Connected, as a circuit for sensing vehicle motion by means of different sensing systems, to the selector circuit 80 are a rotation verification circuit 81 for transmitting a rotation signal k1 of a tire, a speed verification circuit 82 for transmitting a speed signal k2 of the speed meter; and a motion verification circuit 83 for transmitting another motion signal k3. In accordance with a signal input from the circuit selected by the selector circuit 80, the motion sensing section 60 repeatedly feeds to the image comparison computation section 50 an output signal p2 showing whether or not the vehicle is in motion.

The cyclic signal generator 40 for generating a signal equal to a predetermined cycle is connected to the image comparison computation section 50 as well. A cycle at which the image comparison computation section 50 performs comparison is not a fixed value that is a predetermined cycle but can be accordingly changed to the best cycle in accordance with an output signal p3 originated from the cyclic signal generator 40.

In the present embodiment, the cyclic signal generator 40 is equipped with at least one (N) cycle selection terminal 41 or more. The cycle can be changed stepwise by means of only hardware, so long as a signal input to the cycle selection terminal 41 is switched; for instance, between a high level and a low level. Specifically, when one cycle selection terminal 41 is provided, the cyclic signal generator 40 can select a cycle in two levels. Further, when N number (an integer) of the cycle selection terminal 41 are provided, the cyclic signal generator 40 can select a cycle in 2N levels. The image comparison computation section 50 fed with the output signal p3 selected by the cyclic signal generator 40 compares, at a cycle corresponding to the selected output signal p3, current image data with past image data acquired in at least one preceding cycle.

A signal whose level can be varied with an analog volume can also be input, in place of the high/low-level signal to the cycle selection terminal 41. In this case, an analog-to-digital converter circuit (ADC) is interposed between the cyclic signal generator 40 and one cycle selection terminal 41, thereby enabling continual changing of a cycle.

Moreover, a cycle at which the image comparison computation section 50 performs comparison can also be changed by means of software. FIG. 8 is a section diagram showing a configuration employed when a cycle at which the image comparison computation section 50 performs comparison is changed by means of software. A cycle selection register 42 is connected to the cyclic signal generator 40. According to a value set by software, the cycle selection register 42 outputs to the cyclic signal generator 40 an output signal p4 for selecting a cycle.

A width of a cycle (a range of selection) selected by the cycle selection register 42 is dependent on the number of output signals p4 input from the cycle section register 42. When the number of output signals p4 is M, the cyclic signal generator 40 can select a cycle in 2M levels. Further, the output signal p3 selected by the cyclic signal generator 40 is fed to the image comparison computation section 50, whereby the image comparison computation section 50 compares, at a cycle corresponding to the selected output signal p3, the current image data with the past image data acquired in at least one preceding cycle.

Operation of the monitoring system having the above configuration is now described. FIG. 9 is a flowchart showing operation procedures of the monitoring system. The operation is implemented as a function as a result of a CPU in a microcomputer populated in the monitoring system executing a control program stored in memory. The image comparison computation section 50 repeatedly performs operation at a predetermined cycle.

First, in accordance with the output signal p2 input from the motion sensing section 60, the image comparison computation section 50 determines whether or not the vehicle is in motion (step S1). When the vehicle is determined to be inactive, the image comparison computation section 50 terminates processing at once. In the meantime, when the vehicle is determined to be in motion, the image comparison computation section 50 compares current image data with past data obtained in at least one preceding cycle (step S2). A combination of image data to be compared with each other is not limited to that described above, and a combination can be appropriately selected from a plurality of possible combinations.

From a result of comparison between image data, the image comparison computation section 50 determines whether the camera 10 or the image processing section 20 broke down (step S3). When there is not any failure, the image comparison computation section 50 terminates processing straightforward. In the meantime, when there is a failure, the image comparison computation section 50 outputs to the image processing section 20 the output signal p1 reporting the failure (step S4). Upon receipt of the output signal p1, the image processing section 20 processes an image acquired at the time of failure of the camera 10 or the image processing section 20 and outputs an image signal g2 showing image processing information (failure information), thereby changing the display device 30 to a monochrome display or an alarm display. Subsequently, the image comparison computation section 50 terminates processing.

When the monitoring system went down because of any failure while an image preceding an image originally to be displayed still remains on the display device 30, the monitoring system of the first embodiment can report the failure of the monitoring system to the driver. Consequently, the driver can take notice of the failure of the monitoring system and temporarily drives the vehicle to a safe location through use of an ancillary function, like a rearview mirror, thereby enabling avoidance of an accident. Safety of the vehicle can be consequently upgraded, and construction of a safety-sensitive system comes to realization.

Moreover, transmitting failure information by way of the image processing section 20 makes it possible to superimpose alarm information on a display screen or change a display mode, like a color or brightness of an alarm display screen, thereby facilitating the attracting of driver's attention. Further, a failure of the monitoring system can be conveyed to the driver while the vehicle is in motion, so that the driver can avoid an accident. As long as the cycle is made variable, a failure of the monitoring system can be detected at a cycle conforming to motion of the mobile object, like a vehicle.

In addition to including a bug in hardware or software, causes for the failure of the image processing section 20 include a case where the image processing section 20 handling another processing comes to lag behind image processing as a result of a temporal increase in throughput.

In the present embodiment, an alarm about a failure is reported by means of the display screen of the display device 30. The alarm can also be reported by use of the display screen in combination with another method.

### Second Embodiment

FIG. 10 is a section diagram showing a configuration of a monitoring system including another alarm annunciation device added to the configuration described in connection with the first embodiment. Constituent elements that are identical with their counterparts described in connection with the first embodiment are assigned the same reference numerals, and their repeated explanations are omitted. Explanations are hereinbelow given to a configuration and operation that differ from those described in connection with the first embodiment.

The monitoring system shown in FIG. 10 is provided with, as alarm generation medans, an alarm indicator 90 and an alarm sound generator 91 into which the output signal p1 is input from the image comparison computation section 50.

In the present embodiment, the image comparison computation section 50 inputs the output signal p1 reporting the failure to the image processing section 20 and also inputs the output signal p1 to the alarm indicator 90 and the alarm sound generator 91. Aside from the alarm display provided by the display device 30, the alarm indicator 90 provides an alarm display. Further, the alarm sound generator 91 emits an alarm sound. Incidentally, only one of the alarm indicator 90 and the alarm sound generator 91 can be provided and activated.

Aside from the alarm display provided by the display device 30, the alarm indicator 90 thereby provides an alarm display, and the alarm sound generator 91 also emits an alarm sound, thereby making it possible to call the driver's attention to the failure without fail. In particular, even when a failure exists in function between the image processing section 20 and the display device 30, inputting the output signal p1 to the alarm indicator 90 and the alarm sound generator 91 directly from the image comparison computation section 50 makes it possible to call the driver's attention without fail. Moreover, as a result of the output signal p1 being input directly to the alarm indicator 90 and the alarm sound generator 91 without involvement of the image processing section 20 and the image memory 70, a failure can be immediately reported to the driver at the moment of detection of the failure.

### Third Embodiment

FIG. 11 is a section diagram showing a configuration of a monitoring system of a third embodiment. Repeated explanations of constituent elements identical with their counterparts described in connection with the first embodiment are omitted. Explanations are hereinbelow given to a configuration and operation that differ from those described in connection with the first embodiment.

In the present embodiment, the image memory 70 that has been built into the image comparison computation section 50 of the first embodiment is not provided in the image comparison computation section 50. The image memory 51 is provided outside a semiconductor integrated circuit 200. The image memory 70 employed in the present embodiment stores an image signal output from the image processing section 20 and outputs the thus-stored image signal to the display device 30, the image memory 51, and the image comparison computation section 50.

The image memory 51 stores the image signal output from the image memory 70 and outputs the thus-stored image signal to the image comparison computation section 50. On this occasion, an image “n” input from the image memory 70 and an image n−1 one cycle preceding the image “n” input from the image memory 51 are concurrently input to the image comparison computation section 50. When the motion sensing section 60 ascertains that the vehicle is in motion, the image comparison computation section 50 compares the image “n” with the image “n−1” at a predetermined cycle, thereby confirming at all times whether or not the camera 10 or the image processing section 50 broke down.

During failure detection, the image comparison computation section 50 performs image matching, determining similarities between two pieces of image data to be compared with each other (i.e., current image data and past image data). More specifically, when a high correlation exists between the two images, the two images are determined to be substantially identical. Since the two images remain unchanged despite occurrence of a change in circumstances of the surroundings of the vehicle, a failure is determined to exist. In the meantime, when a low correlation exists between the two images, the two images are determined to be different from each other. Hence, it is determined that there is not any failure. In the event of a failure, the image comparison computation section 50 outputs to the image processing section 20 an output signal p1 reporting the failure.

Upon receipt of the output signal p1, the image processing section 20 performs image processing intended for the case of failure of the camera 10 or the image processing section 20. Specifically, the image processing section 20 outputs an image signal showing image processing information (failure information), thereby changing the display on the display device 30 to a monochrome display or an alarm display. Incidentally, the above operation is based on the premise that the image processing section 20 maintains a normal failure-free function of performing image processing for failure and transmitting failure information to the display device 30.

Having detected a failure, the image comparison computation section 50 halts subsequent image comparison. On this occasion, the display device 30 preferentially displays an alarm.

As above, the external memory of the semiconductor integrated circuit 200 is utilized rather than the image memory 51 being built in the image comparison computation section 50, thereby making it possible to miniaturize the semiconductor integrated circuit.

The cyclic signal generator 40 can also be connected to the image comparison computation section 50 in the same manner as described in connection with the first embodiment. A cycle at which the image comparison computation section 50 performs comparison is not a fixed value that is a predetermined cycle but can be accordingly changed to the best cycle in accordance with the output signal p3 originated from the cyclic signal generator 40. In this regard, the cycle selection terminal 41 or the cycle selection register can also be connected to the cyclic signal generator 40, thereby changing a cycle. In addition, aside from the alarm display provided by the display device 30, the alarm display provided by the alarm indicator 90 or the alarm sound emitted by the alarm sound generator 91 can also be generated as mentioned in connection with the first embodiment.

### Fourth Embodiment

FIG. 12 is a section diagram showing a configuration of a monitoring system of a fourth embodiment. Repeated explanations of constituent elements identical with their counterparts described in connection with the first embodiment are omitted. Explanations are hereinbelow given to a configuration and operation that differ from those described in connection with the first embodiment.

In the present embodiment, the image memory 70 disposed outside the semiconductor integrated circuit in the first embodiment is provided within a semiconductor integrated circuit 300. In all other respects, the monitoring system is similar to that described in connection with the first embodiment in terms of execution and processing.

As mentioned above, placing the image memory 70 in the semiconductor integrated circuit makes it possible to shorten a signal transmission distance and prevent occurrence of a delay in signal transmission. There is also yielded an advantage of a reduction in both power consumption and area of a substrate on which a semiconductor integrated circuit is populated.

The cyclic signal generator 40 can also be connected to the image comparison computation section 50 in the same manner as described in connection with the first embodiment. A cycle at which the image comparison computation section 50 performs comparison can also be accordingly changed to the best cycle in accordance with the output signal p3 originated from the cyclic signal generator 40 rather than being a fixed predetermined cycle. In this regard, the cycle selection terminal 41 or the cycle selection register can also be connected to the cyclic signal generator 40, thereby changing a cycle. In addition, aside from the alarm display provided by the display device 30, the alarm display provided by the alarm indicator 90 or the alarm sound emitted by the alarm sound generator 91 can also be generated as mentioned in connection with the first embodiment.

The first to fourth embodiments show the cases where the monitoring system is applied to the vehicle. However, the present invention is also applicable to mobile objects other than the vehicle in the same fashion. Mobile objects other than the vehicle include movable monitoring cameras, and the like.

In the first through fourth embodiments, the monitoring system has simply been described as a system that is wholly constructed as a unit. However, an external camera, an external display device, and a monitoring unit with other built-in sections can also be constructed separately from each other.

The present invention, however, is not limited to the configurations described in connection with the first through fourth embodiments. The present invention is applicable to any configuration, so long as the configuration enables implementation of the functions described in connection with claims or functions exhibited by the configurations described in connection with the first through fourth embodiments. Although the present invention has been described in detail and by reference to the specific embodiments, it is manifest to those skilled in the art that the present invention be susceptible to various modifications or alterations without departing the spirit and scope of the present invention.

The disclosure of Japanese Patent Application No. 2010-049740 filed on Mar. 5, 2010, including specification, drawings, and claims is incorporated herein by reference in its entirety.

The monitoring system of the present invention is useful as a monitoring system that reports occurrence of a failure to the user when an image preceding an image to be originally displayed still remains displayed on a display device.

What is claimed is:

1. A monitoring system that monitors a mobile object comprising:
a camera that captures an image of surroundings and outputs an image signal;
an image processing section that processes the image signal input from the camera so as to generate image data;
a display device that displays an image according to the image data generated by the image processing section;
a motion sensing section that senses that the mobile object is in motion; and
an image comparison section that receives an input of the image data generated by the image processing section at a predetermined cycle and that compares first image data generated by the image processing section with second image data generated in at least one cycle preceding the first image data when the motion sensing section detects that the mobile object is in motion, wherein
the image comparison section has
a determination section that determines, from a comparison result, whether there is a failure in the camera or the image processing section; and
a transmission section transmitting failure information to the display device when the determination section determines that there is the failure.

2. The monitoring system according to claim 1, further comprising:
a first memory and a second memory that store image data generated by the image processing section;
wherein the first memory stores the first image data, and the second memory stores the second image data.

3. The monitoring system according to claim 2, wherein each of the first memory and the second memory has at least two pieces of image data or more.

4. The monitoring system according to claim 1, wherein the image comparison section halts image comparison when the failure is detected.

5. The monitoring system according to claim 2, wherein the second memory is provided within the image comparison section.

6. The monitoring system according to claim 1, wherein the failure information transmitted from the image comparison section is transmitted to the display device by way of the image processing section.

7. The monitoring system according to claim 6, further comprising a device for reporting a failure in addition to the display device, wherein the failure information transmitted from the image comparison section is transmitted to the device for reporting the failure without involvement of the image processing section.

8. The monitoring system according to claim 1, wherein the display device provides a monochrome display or an alarm display in accordance with the failure information transmitted by the transmission section.

9. The monitoring system according to claim 1, wherein, when the mobile object is a vehicle, the motion sensing section senses that the vehicle is in motion by use of a tire rotation signal and a speed signal or an operation signal of a speed meter.

10. The monitoring system according to claim 1, wherein the image processing section has a captured image processing section, an alarm display image generation section, and a display image selection section; and,
when the image comparison section determines that there is a failure, the display image selection section causes the display device to display image data generated by the alarm display image generation section in preference to the image data generated by the captured image processing section.

11. The monitoring system according to claim 1, wherein at least the image processing section, the motion sensing section, and the image comparison section are implemented on one semiconductor integrated circuit substrate.

12. The monitoring system according to claim 11, wherein at least one of the first memory and the second memory includes an external memory disposed outside the semiconductor integrated circuit substrate.

13. The monitoring system according to claim 1, further comprising:
a signal generation section generating a signal corresponding to the predetermined cycle with respect to the image comparison section, wherein
the signal generation section is configured by a hardware capable of changing the cycle or a combination of the hardware with software.

14. A method for controlling a monitoring system that monitors a mobile object comprising:
an image processing step of processing an image signal input from a camera that captures an image of surroundings and outputs an image signal so as to generate image data;
a display step of displaying an image according to the image data generated in the image processing step;
a motion sensing step of sensing that the mobile object is in motion;
an image comparison step of receiving an input of image data generated in the image processing step at a predetermined cycle and comparing current image data generated in the image processing step with past image data generated in at least one cycle preceding generation of the image data when it is detected in the motion sensing step that the mobile object is in motion;
a determination step of determining, from a comparison result, whether there is a failure in the camera or an image processing section; and
a transmission step of transmitting failure information to a display device when it is determined in the determination step that there is the failure.

15. A semiconductor integrated circuit comprising:
an image processing section that processes an image signal input from a camera so as to generate image data;
a motion sensing section sensing that the mobile object is in motion; and
an image comparison section that receives an input of image data generated by the image processing section at a predetermined cycle and that compares first image data generated by the image processing section with second image data generated in at least one cycle preceding the first image data when the motion sensing section detects that the mobile object is in motion, wherein
the image comparison section has
a determination section that determines, from a comparison result, whether there is a failure in the camera or the image processing section; and wherein
failure information is output when the determination section determines that there is the failure.
